(19) United States
(12) Patent Application Publication
(10) Pub. No.: US 2026/0268731 A1
(43) Pub. Date: Sep. 10, 2026

(54) Presenting Betting Promotions using Betting History

(71) Applicant: DISH Wireless L.L.C., Littleton, CO (US)

(72) Inventor: Eric Pleiman, Centennial, CO (US)

(21) Appl. No.: 19/075,493

(22) Filed: Mar. 10, 2025

(51) Int. Cl. G07F 17/32

(52) U.S. Cl. CPC G07F 17/323; G07F 17/3288

(57) ABSTRACT

Techniques for presenting betting promotions are described. An example method includes generating a gaming user interface (UI) that includes one or more UI elements that indicate one or more promotions available from one or more betting platforms that are individually selectable, wherein the one or more promotions are based on betting history data associated with a viewer of the gaming UI; causing the gaming UI to be presented on a display concurrently with programming received from a service provider system; receiving a selection of a promotion from the one or more promotions, wherein the promotion is associated with a betting platform from the one or more betting platforms; and transmitting an indication of the selection of the promotion to one or more of the service provider system or the betting platform.

### BACKGROUND

Many jurisdictions allow residents to legally wager/bet on sporting events and/or other activities. Users typically make and monitor their bets through different online betting platforms, such as online sports betting platforms. In many cases, a user may have accounts at many different betting platforms. Interacting with these different platforms, however, may be cumbersome to bettors.

### SUMMARY

Various arrangements for presenting betting promotions are presented. Such arrangements can include methods, systems, non-transitory processor-readable mediums and devices. In some examples, a receiving device, which may be referred to herein as a “receiver”, receives programming (e.g., television) from a service provider system (e.g., a service provider system). The receiver may output the programming received from the service provider system for presentation, such as to a television. The receiver may also generate and output a gaming user interface (UI) to be presented near with the programming for presentation.

The gaming UI can present current betting promotions, which may be referred to herein as “promotions”, that are individually selectable by a viewer (e.g., a user) of the programming via a remote control of the receiver. In some examples, promotions can be determined from the promotions that currently available from one or more betting platforms. For example, a user may specify the betting platforms to include. In other examples, the betting platforms to check for current promotions may be based on some other criteria (e.g., popularity, amount of discount, . . . ). As will be discussed in more detail below, the techniques described herein determine and display betting promotions that the user may be interested in wagering on based on past betting behavior. A selection of a promotion can be received from the promotions presented in the gaming UI. In response to the selection, the receiver may transmit a wager identifier of the first selected promotion and an account identifier to the service provider system. The wager identifier and the account identifier may be transmitted to a betting platform (e.g., an online betting platform, . . . ) and/or a gaming server system that is distinct from the service provider system.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for presenting betting promotions. The method includes generating, by one or more processors, a gaming user interface (UI) that includes one or more UI elements that indicate one or more promotions available from one or more betting platforms that are individually selectable, wherein the one or more promotions are based on betting history data associated with a viewer of the gaming UI; causing, by the one or more processors, the gaming UI to be presented on a display concurrently with programming received from a service provider system; receiving, by the one or more processors, a selection of a promotion from the one or more promotions, wherein the promotion is associated with a betting platform from the one or more betting platforms; and transmitting, by the one or more processors, an indication of the selection of the promotion to one or more of the service provider system or the betting platform.

Other examples of this aspect include corresponding computer systems, apparatus, and computer programs recorded on one or more computer storage devices, each configured to perform the actions of the methods.

### BRIEF DESCRIPTION OF THE DRAWINGS

FIG. 1 illustrates an example of an integrated television wagering system, according to various examples of the present disclosure.

FIG. 2 illustrates an example of a television distribution system, according to various examples of the present disclosure.

FIG. 3 illustrates an example of a receiver, according to various examples of the present disclosure.

FIG. 4A illustrates an example of a gaming user interface displayed at a first location on the screen.

FIG. 4B illustrates an example of a gaming user interface in which a viewer selects a particular promotion, according to various examples of the present disclosure.

FIG. 4C illustrates an example of a gaming user interface displayed at a second location on the screen, according to various examples of the present disclosure.

FIG. 4D illustrates an example of a gaming user interface displayed at a third location on the screen, according to various examples of the present disclosure.

FIG. 4E illustrates an example of a gaming user interface displayed at a fourth location on the screen, according to various examples of the present disclosure.

FIG. 4F illustrates an example of a gaming user interface displayed at a fifth location on the screen, according to various examples of the present disclosure.

FIG. 5 illustrates an example of a user interface in which a viewer selects a gaming application to sign up for a promotion, according to various examples of the present disclosure.

FIG. 6A illustrates an example of a neural network that has been trained to generate a recommendation of one or more promotions to include within a gaming user interface, according to various examples of the present disclosure.

FIG. 6B is a diagram illustrating an example of a neuron, according to various examples of the present disclosure.

FIG. 7 is a flow diagram illustrating a process for determining and displaying promotions based on betting history, according to an example of the present disclosure.

FIG. 8 a flow diagram illustrating a process for training and updating one or more ML models, according to an example of the present disclosure.

FIG. 9 illustrates an example computer system or computer device, according to various examples of the present disclosure.

### DETAILED DESCRIPTION

The present disclosure provides systems, devices, and methods that generally relate to presenting betting promotions to a user. Instead of the user having to login to one or more betting platforms (e.g., online sites, applications, . . . ) to determine if there is a betting promotion, which may be referred to herein as “promotion”, that they are interested in wagering on, the techniques described herein determine and display betting promotions that the user may be interested in wagering on based on past betting behavior. In some examples, when a user turns on their television (TV), a gaming manager determines the betting promotions to display to the user within a gaming UI.

In some examples, the gaming manager uses one or more machine learning (ML) techniques to analyze the betting history of the user (e.g., the current viewer of a television) across one or more of the wagering accounts for one or more betting platforms to determine current betting promotions that are likely to be wagered on by the user. Generally, the ML techniques analyze the past betting history by the user on each of betting platforms to determine the types of promotions the user typically wagers on and/or prefers to wager on. The gaming manager uses the output of the ML model(s) to select the promotions to display.

According to some configurations, the ML models may be trained and updated using data obtained directly from one or more betting platforms. In some cases, the ML models may refer to the deployment of artificial intelligence algorithms and models directly on devices, such as receivers, computing devices, mobile computing devices, and/or performed by one or more processors in centralized data centers or cloud environments. These devices can include smartphones, IoT devices, industrial machines, and the like. In these examples, the devices may be able to process and analyze data locally on the IoT devices themselves.

The selected promotions may be displayed on a TV, or some other type of display. For example, a banner may be displayed at the top/bottom/sides of a TV screen with the selected promotions and the betting platform provider(s). As an example, the banner may include a promotion such as, but not limited to “Betting Platform 1 has a 25% boost on MLB today; Betting Platform 2 has a no sweat bet on WNBA game (get your bet back in a bonus bet); Betting Platform 3 has an up to 100% bonus on a four-leg parley, and the like”.

According to some configurations, before displaying the promotions, the gaming manager may authenticate/confirm that the user is authorized to make a wager/bet. For instance, the gaming manager may determine that the user is currently located in a state that has legalized gambling, and that the user is old enough to make a wager. The gaming manager may also be configured to only display wagering promotions that are applicable within the current location of the user. For example, if the user is in Colorado, the promotion may be related to the Denver Broncos, Colorado Rockies, or some other wagering promotion in Colorado, whereas if the user is in Missouri, the wagering promotion may be for the KC Chiefs, or some other wagering promotion available in Missouri.

In some examples, the display of the promotions can be turned on/off either manually and/or programmatically. For instance, when a user is detected and authenticated, the display of the promotions can be turned on. In another instance, when a user is detected but not authenticated, the display of the promotions can be turned off. In some cases, a user may specify the betting platform(s) to include to determine what promotions to display. In other cases, the promotions may be determined from one or more of the available wagering applications/sites that are available within the location of the user.

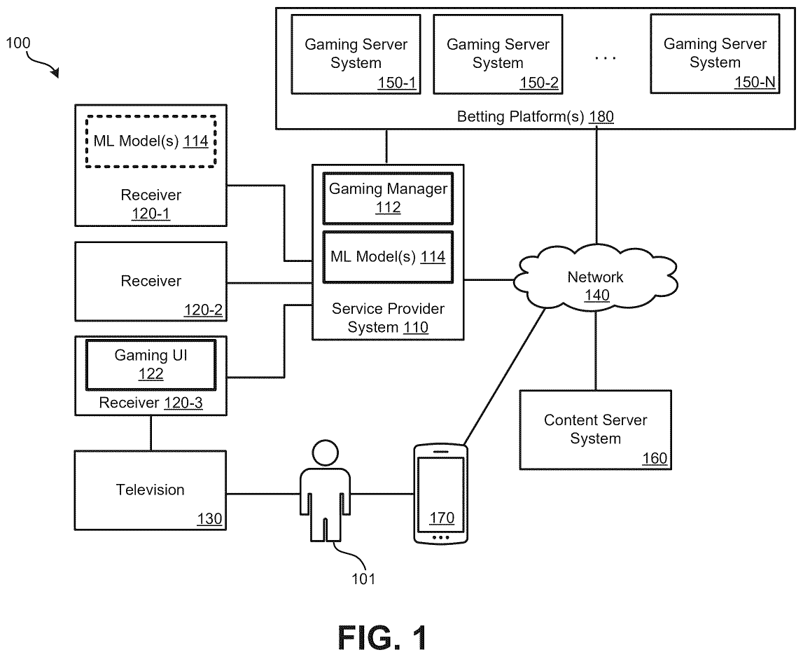

FIG. 1 illustrates an example of an integrated television wagering system 100 (“system 100”). System 100 can include: service provider system 110; receivers 120 (120-1, 120-2, 120-3); television 130; network 140; gaming server system 150; content server system 160; mobile device 170, and betting platform(s) 180. Person 101 can be referred to as a “television viewer”, “bettor”, and/or “user”.

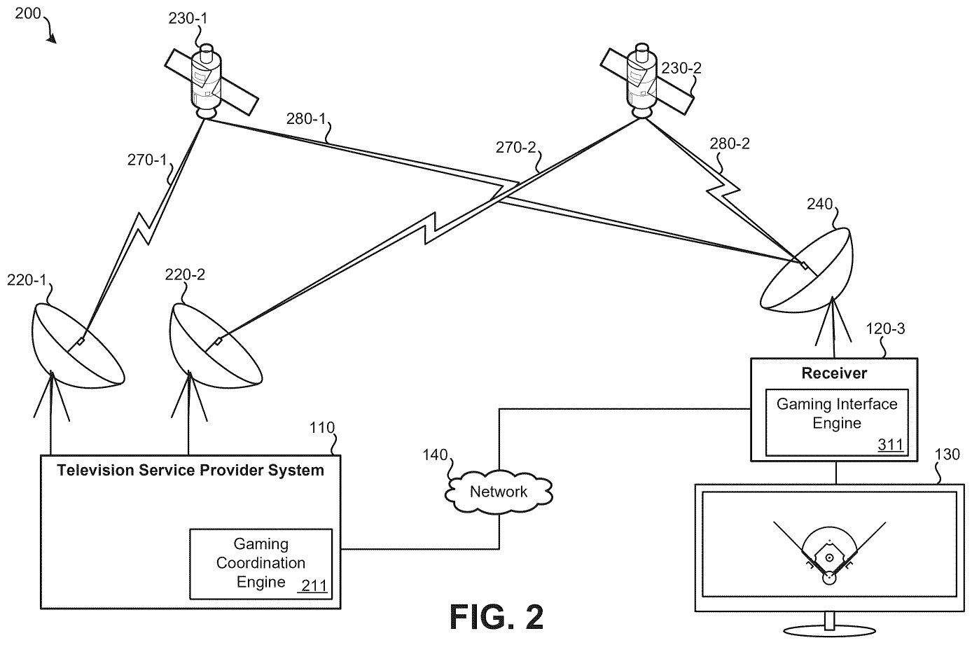

Service provider system 110 may broadcast live television programming, as well as other types of programming, to receivers 120. “Live” television programming refers to television programming that is transmitted substantially contemporaneously with the event occurring. Live television programming may include a delay of up to several minutes. For instance, a sporting event that is broadcast with a delay of up to a few minutes, such as to edit out offensive audio, would qualify as live television programming. Such live television programming may be received from various content providers, then relayed by service provider system 110 to receivers 120. Streams of many television channels may be broadcast live via various types of television programming distribution networks, such as a satellite-based network, cable-based network, IP-based network, or over-the-top (OTT) television distribution network, which may operate using an Internet connection. In addition to streaming live television channels, service provider system 110 may transmit on-demand content to receivers 120, applications for execution, electronic programming guide (EPG) data, metadata, and other services ancillary to live television programming. Further detail regarding a possible example of service provider system 110 is provided in relation to FIG. 2.

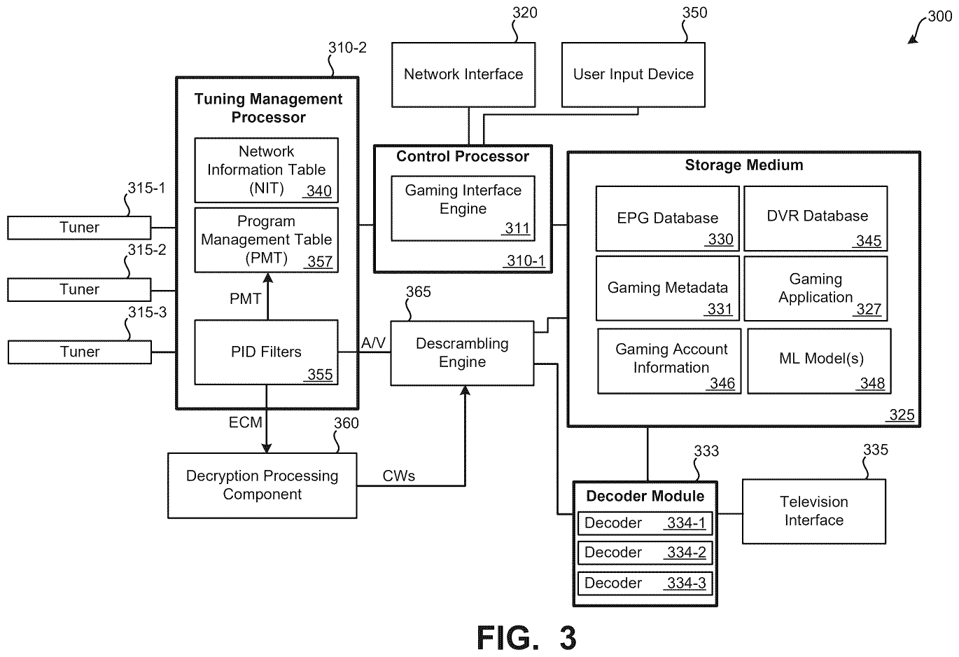

While three receivers 120 are presented, this number of receivers is merely for illustration—many more receivers may receive live television programming from service provider system 110 in other examples. A receiver, such as receiver 120-3, may be integrated as part of a television or other form of display device or may be a separate device, such as a set top box (STB), that receives data from service provider system 110 and outputs the data for presentation, such as to television 130. Further detail regarding examples of receivers 120 is provided in relation to FIG. 3.

Additionally or alternatively, some other form of device that is capable of outputting television programming may be used instead of receivers 120. For instance, television programming, such as a live sporting event, may be distributed over an IP network (e.g., including the Internet) using an OTT (over-the-top) distribution network. A computerized device, such as a smartphone, gaming device, or tablet computer may be used to view the programming and output a gaming UI, such as detailed in relation to the figures below.

Service provider system 110 may use a dedicated television-distribution network to communicate with receivers 120. Additionally, or alternatively, network 140 may be used to communicate with receivers 120 and/or gaming server system 150, and content server system 160. Network 140 may include one or more public and/or private networks, which can include the Internet.

Gaming server systems 150 illustrated within betting platforms 180 may be operated by entities that are distinct from the entity operating service provider system 110. Each of the gaming server systems 150 may host various wagers and may be used to set the odds on the wagers. A person located in a jurisdiction that permits gaming and is of the correct age may be permitted to place a wager via a gaming server system 150. A person may be able to access gaming server system 150 using a computerized device, such as mobile device 170. Mobile device 170 may allow television viewer 101 to access a gaming server system 150 via an application installed on mobile device 170 or by using a web browser on mobile device 170 to access the website of gaming server system 150. Mobile device 170 may be a smart phone, gaming device, tablet computer, laptop computer, cellular phone, desktop computer, personal digital assistant, or some other form of computerized device.

Service provider system 110 may communicate with a gaming server system 150 via network 140. Sports gaming server system 150 may provide an indication of various wagers and the associated odds with such wagers to service provider system 110. A sports gaming server system 150 may also provide current betting promotions to service provider system 110. In some examples, the gaming manager 112 of the service provider system 110 uses one or more machine learning (ML) models 114 to analyze the betting history of the user (e.g., the current viewer of a television) across one or more of the wagering accounts for one or more of the betting platforms 180 to determine current betting promotions that are likely to be wagered on by the user. For example, the gaming manager 112 may obtain betting history from each account that the user has authorized the gaming manager 112 to access.

According to some configurations, the ML model(s) 114 analyze the past betting history to determine the types of promotions the user typically wagers on and/or prefers to wager on. For example, the gaming manager 112 may determine, using one or more of the ML models 114, that the user prefers to place “bonus bets”, and “odd boosts”, but does not bet “parlay”, or “profit boost” bets. The gaming manager uses the output of the ML model(s) to select the current promotions to display to the user.

According to some configurations, the ML models 114 can be trained and updated using data obtained directly from one or more betting platforms. In some cases, the ML models 114 refer to the deployment of artificial intelligence algorithms and models directly on devices, such as on the service provider system 110, receivers 120, mobile devices (e.g., device 170), computers, and/or performed by one or more processors in centralized data centers or cloud environments. These devices can include smartphones, IoT devices, industrial machines, and the like. In these examples, the devices may be able to process and analyze data locally on the IoT devices themselves

Service provider system 110 may relay betting information and/or promotions to display to receivers 120. Sports gaming server system 150 may also transmit indications of wagers placed by particular television viewers to service provider system 110. Service provider system 110 may relay promotions and/or wagers placed by a particular television viewer to the television viewer's receiver for presentation.

Content server system 160 may provide information ancillary to betting to service provider system 110. For example, gaming server system 150 may indicate the particular wagers and odds that can be placed by a television viewer on a sporting event and content server system 160 may provide service provider system 110 with details on the sporting event, such as the television station, the time of the sporting event, details of the teams and players participating in the sporting event (e.g., team records, player-specific statistics), the location of the sporting event, and/or other details of the sporting event.

Television viewer 101 may be using television 130 to view the sporting event. The sporting event may be received as live television programming by receiver 120-3 from service provider system 110. Television viewer 101 may use a remote control to interact with receiver 120-3. Television viewer 101 has an option to view a gaming UI. In some examples, some other form of electronic device may be used, such as a computerized mobile device or smartphone. This gaming UI can be output concurrently with television programming, such as the live sporting event being viewed by television viewer 101. The gaming UI 122 may function as an application that is installed on receiver 120-3. service provider system 110 may have previously transmitted data to all of receivers 120 or in response to a request for a particular receiver initiated by a user, such as television viewer 101. Various examples of such a gaming UI are detailed in relation to the figures below.

Viewer 101 may also be using mobile device 170. Viewer 101 may, via the gaming UI output by receiver 120-3, trigger one or more wagers/promotions to be transmitted to mobile device 170. In such examples, the gaming UI 122 executed by receiver 120-3 may be used to communicate with service provider system 110 and/or betting platform(s) 180. In some examples, the gaming UI may communicate information that indicates a selected promotion that the viewer 101 would like to wager on. Service provider system 110 can relay this information to a gaming server system 150 via network 140. Alternatively, the gaming UI 122 may use an application programming interface (API) to relay an indication of the one or more wagers/promotions to the gaming server system 150 (without communicating through service provider system 110). Gaming server system 150 may then be triggered to transmit a link or notification to mobile device 170.

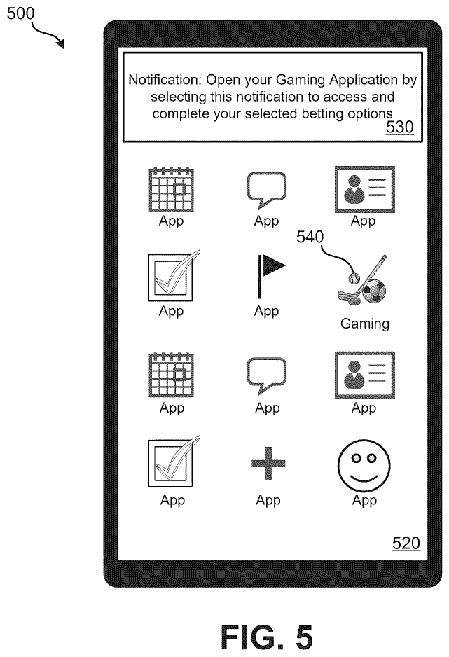

In some examples, a pop-up notification is presented on mobile device 170, such as illustrated in FIG. 5, that can be selected by viewer 101. Selection of such notification may cause a website or application executed by mobile device 170 to launch that will include the wagers/promotions selected by viewer 101 via the gaming UI output by receiver 120-3. In other examples, a link may be sent, such as via text message or email, to mobile device 170. Again here, selecting the link may cause a website or application executed by mobile device 170 to launch that will include the wagers/promotions selected by viewer 101 of the gaming UI output by receiver 120-3. Television viewer 101 may then edit, fund, and/or otherwise complete the selected wagers/selected via the gaming UI.

In some examples, receiver 120-3 can communicate with mobile device 170. After viewer 101 has pre-staged one or more wagers using the gaming UI output by receiver 120-3, viewer 101 can trigger presentation of a machine-readable code, such as a barcode or QR (Quick Response) code, to be output by receiver 120-3 and presented via television 130. The machine-readable code may be read by mobile device 170 using an application for reading machine-readable codes or functionality integrated into a gaming application associated with gaming server system 150. The machine-readable code may have identifiers of the promotions embedded. These identifiers may be used by gaming server system 150 to cause mobile device 170 to present the wagers/promotions and allow television viewer 101 to edit, fund, and/or otherwise complete the wagers/promotions.

In some examples, a machine-readable code, such as a barcode or QR code, may be used to pair a television viewer's gaming account with a receiver. The gaming application may be caused by a viewer to present a machine-readable code. From the television viewer's mobile device or from within the gaming application on the television viewer's mobile device, the machine-readable code may be captured. The gaming application may use information captured from the machine-readable code, such as an identifier, to map the user account active on the mobile device with the instance of the gaming application on the receiver.

Alternatively, an indication of such bets and an associated identifier may be transmitted by receiver 120-3 to service provider system 110, which may relay the information to gaming server system 150. The associated identifier may be embedded in the machine-readable code and may be acquired by mobile device 170 by imaging the machine-readable code. The associated identifier may then be transmitted by mobile device 170 to gaming server system 150 to retrieve the wagers/promotions that are mapped to the identifier.

FIG. 2 illustrates an example of a satellite-based television distributions system 200. Satellite-based television distribution system 200 may include: service provider system 110, satellite transmitter equipment 220, satellites 230, satellite antenna 240, receiver 120-3, and television 130. Alternate examples of satellite-based television distribution system 200 may include fewer or greater numbers of components. While only one satellite antenna 240, receiver 120-3, and television 130 (which can collectively be referred to as “user equipment”) are illustrated, it should be understood that multiple (e.g., tens, thousands, millions) instances of user equipment may receive television signals from service provider system 110 via satellites 230.

Service provider system 110 and satellite transmitter equipment 220 may be operated by a television service provider. A television service provider may distribute television channels that distribute live television programming, on-demand programming, programming information, data, firmware updates, and/or other content/services to users. service provider system 110 may receive feeds of one or more live television channels from various sources. Such television channels may include multiple television channels that contain at least some of the same content (e.g., network affiliates). To distribute television channels for presentation to users, feeds of the television channels may be relayed to user equipment via multiple television distribution satellites. Each satellite may relay multiple transponder streams. Satellite transmitter equipment 220 (120-1, 220-2) may be used to transmit a feed of one or more television channels from service provider system 110 to one or more satellites 230. While a single service provider system 110 and satellite transmitter equipment 220 are illustrated as part of satellite-based television distribution system 200, it should be understood that multiple instances of transmitter equipment may be used, possibly scattered geographically, to communicate with satellites 230. Such multiple instances of satellite transmitting equipment may communicate with the same or with different satellites. Different television channels may be transmitted to satellites 230 from different instances of transmitting equipment. For instance, a different satellite antenna of satellite transmitter equipment 220 may be used for communication with satellites in different orbital slots.

Satellites 230 may be configured to receive signals, such as streams of television channels, from one or more satellite uplinks such as satellite transmitter equipment 220. Satellites 230 may relay received signals from satellite transmitter equipment 220 (and/or other satellite transmitter equipment) to multiple instances of user equipment via transponder streams. Different frequencies may be used for uplink signals 270 from transponder streams 280. Satellites 230 may be in geosynchronous orbit. Each of the transponder streams transmitted by satellites 230 may contain multiple television channels transmitted as packetized data. For example, a single transponder stream may be a serial digital packet stream containing multiple television channels. Therefore, packets for multiple television channels may be interspersed.

Multiple satellites 230 may be used to relay television channels from service provider system 110 to satellite antenna 240. Different television channels may be carried using different satellites. Different television channels may also be carried using different transponders of the same satellite; thus, such television channels may be transmitted at different frequencies and/or different frequency ranges. As an example, a first and second television channel may be relayed via a first transponder of satellite 230-1. A third, fourth, and fifth television channel may be relayed via a different satellite or a different transponder of the same satellite relaying a transponder stream at a different frequency. A transponder stream transmitted by a particular transponder of a particular satellite may include a finite number of television channels, such as seven. Accordingly, if many television channels are to be made available for viewing and recording, multiple transponder streams may be necessary to transmit the television channels to the instances of user equipment. Each transponder stream may be able to carry a finite amount of data. As such, the number of television channels that can be included in a particular transponder stream may be at least partially dependent on the resolution of the video of the television channel. For example, a transponder stream may be able to carry seven or eight television channels at a high resolution, but may be able to carry dozens, fifty, a hundred, two hundred, or some other number of television channels at reduced resolutions.

Satellite antenna 240 may be a piece of user equipment that is used to receive transponder streams from one or more satellites, such as satellites 230. Satellite antenna 240 may be provided to a subscriber for use on a subscription basis to receive television channels provided by the service provider system 110, satellite transmitter equipment 220, and/or satellites 230. Satellite antenna 240, which may include one or more low noise blocks (LNBs), may be configured to receive transponder streams from multiple satellites and/or multiple transponders of the same satellite. Satellite antenna 240 may be configured to receive television channels via transponder streams on multiple frequencies. Based on the characteristics of receiver 120-3 and/or satellite antenna 240, it may only be possible to capture transponder streams from a limited number of transponders concurrently. For example, a tuner of receiver 120-3 may only be able to tune to a single transponder stream from a transponder of a single satellite at a given time. The tuner can then be re-tuned to another transponder of the same or a different satellite. A receiver 120-3 having multiple tuners may allow for multiple transponder streams to be received at the same time.

In communication with satellite antenna 240 may be one or more receivers. Receivers may be configured to decode signals received from satellites 230 via satellite antenna 240 for output and presentation via a display device, such as television 130. A receiver may be incorporated as part of a television or may be part of a separate device, commonly referred to as a set-top box (STB). Receiver 120-3 may decode signals received via satellite antenna 240 and provide an output to television 130. FIG. 2 provides additional detail of various examples of a receiver. A receiver is defined to include set-top boxes (STBs) and also circuitry having similar functionality that may be incorporated with another device. For instance, circuitry similar to that of a receiver may be incorporated as part of a television. As such, while FIG. 2 illustrates an example of receiver 120-3 as separate from television 130, it should be understood that, in other examples, similar functions may be performed by a receiver integrated with television 130.

Television 130 may be used to present video and/or audio decoded and output by receiver 120-3. Receiver 120-3 may also output a display of one or more interfaces to television 130, such as an electronic programming guide (EPG). In many examples, television 130 is a television. Television 130 may also be a monitor, computer, or some other device configured to display video and, possibly, play audio.

Uplink signal 270-1 represents a signal between satellite transmitter equipment 220 and satellite 230-1. Uplink signal 270-2 represents a signal between satellite transmitter equipment 220 and satellite 230-2. Each of uplink signals 270 may contain streams of one or more different television channels. For example, uplink signal 270-1 may contain a first group of television channels, while uplink signal 270-2 contains a second group of television channels. Each of these television channels may be scrambled such that unauthorized persons are prevented from accessing the television channels.

Transponder stream 280-1 represents a transponder stream signal between satellite 230-1 and satellite antenna 240. Transponder stream 280-2 represents a transponder stream signal between satellite 230-2 and satellite antenna 240. Each of transponder streams 280 may contain one or more different television channels, which may be at least partially scrambled. For example, transponder stream 280-1 may be a first transponder stream containing a first group of television channels, while transponder stream 280-2 may be a second transponder stream containing a different group of television channels. When a television channel is received as part of a transponder stream and is decoded and output to television 130 (rather than first storing the television channel to a storage medium as part of DVR functionality, then later outputting the television channel from the storage medium), the television channel may be considered to be viewed “live.”

FIG. 2 illustrates transponder stream 280-1 and transponder stream 280-2 being received by satellite antenna 240 and distributed to receiver 120-3. For a first group of television channels, satellite antenna 240 may receive transponder stream 280-1 and for a second group of channels, transponder stream 280-2 may be received. Receiver 120-3 may decode the received transponder streams. As such, depending on which television channels are desired to be presented or stored, various transponder streams from various satellites may be received, descrambled, and decoded by receiver 120-3.

Network 140 may serve as a secondary communication channel between service provider system 110 and receiver 120-3. However, in many instances, receiver 120-3 may be disconnected from network 140 (for reasons such as because receiver 120-3 is not configured to connect to network 140 or a subscriber does not desire or cannot connect to network 140). As such, the connection between network 140 and receiver 120-3 is represented by a dotted line. Via such a secondary communication channel, bidirectional exchange of data may occur. As such, data may be transmitted to service provider system 110 from receiver 120-3 via network 140. Data may also be transmitted from service provider system 110 to receiver 120-3 via network 140. Network 140 may be the Internet. While audio and video services may be provided to receiver 120-3 via satellites 230, feedback from receiver 120-3 to service provider system 110 may be transmitted via network 140. In some examples, gaming data to populate the gaming application may be sent via satellites 230 such that a television viewer can use the gaming application even if no internet application is available to receiver 120-3.

Service provider system 110, which can include one or more computer server systems, can execute gaming coordinate engine 211. Coordination engine 211 may serve as an intermediary between receivers and server system 150. Coordination engine 211 may forward information from server system 150 to the appropriate receiver. Coordinate engine 211 may forward information from a receiver, such as receiver 120-3, to server system 150. Gaming coordinate engine 211 may maintain a datastore that indicates an account identifier or receiver identifier that is mapped to an account identifier. Therefore, if coordinate engine 211 receives data mapped to a particular account identifier, service provider system 110 can forward the information, either via network 140 or via satellite, to the appropriate receiver.

FIG. 3 illustrates an example of a receiver 300. Receiver 300 may be in the form of a separate device configured to be connected with a display device, such as a television. Examples of receiver 300 can include set top boxes (STBs). As previously noted, in addition to being in the form of an STB, a receiver may be incorporated as part of another device, such as a television or other form of display device. For example, a television may have an integrated receiver (which does not involve an external STB being coupled with the television).

Receiver 300 may represent any of receivers 120 of FIG. 1 and may be in the form of an STB that outputs video and/or audio to a display device, such as a television. Receiver 300 may include: processors 310 (which may include control processor 310-1, tuning management processor 310-2, and possibly additional processors), tuners 315, network interface 320, non-transitory computer-readable storage medium 325, electronic programming guide (EPG) database 330, television interface 335, networking information table (NIT) 340, digital video recorder (DVR) database 345 (which may include provider-managed television programming storage and/or user-defined television programming), gaming application 327, gaming metadata 331, gaming account information 346, ML model(s) 348, user input device 350, decryption processing component 360 (which can be in the form of a removable or non-removable smartcard), and/or descrambling engine 365. In other examples of receiver 300, fewer or greater numbers of components may be present. It should be understood that the various components of receiver 300 may be implemented using hardware, firmware, software, and/or some combination thereof. Functionality of components may be combined; for example, functions of descrambling engine 365 may be performed by tuning management processor 310-2. Further, functionality of components may be spread among additional components; for example, PID (packet identifier) filters 355 may be handled by separate hardware from program management table 357.

Processors 310 may include one or more specialized and/or general-purpose processors configured to perform processes such as tuning to a particular channel, accessing and displaying EPG information from EPG database 330, and/or receiving and processing input from a user. For example, processors 310 may include one or more processors dedicated to decoding video signals from a particular format, such as MPEG, for output and display on a television and for performing decryption. It should be understood that the functions performed by various modules of FIG. 3 may be performed using one or more processors. As such, for example, functions of descrambling engine 365 may be performed by control processor 310-1.

Control processor 310-1 may communicate with tuning management processor 310-2. Control processor 310-1 may control the recording of television channels based on timers stored in DVR database 345. Control processor 310-1 may also provide commands to tuning management processor 310-2 when recording of a television channel is to cease. In addition to providing commands relating to the recording of television channels, control processor 310-1 may provide commands to tuning management processor 310-2 that indicate television channels to be output to decoder module 333 for output to a display device. Control processor 310-1 may also communicate with network interface 320 and user input device 350. Control processor 310-1 may handle incoming data from network interface 320 and user input device 350. Additionally, control processor 310-1 may be configured to output data via network interface 320. Control processor 310-1 may execute gaming UI engine 311.

Tuners 315 may include one or more tuners used to tune to transponders that include broadcasts of one or more television channels. In the illustrated example of receiver 300, three tuners are present (tuner 315-1, tuner 315-2, and tuner 315-3). In other examples, two or more than three tuners may be present, such as four, six, or eight tuners. Each tuner contained in tuners 315 may be capable of receiving and processing a single transponder stream from a satellite transponder at a given time. As such, a single tuner may tune to a single transponder stream at a given time. If tuners 315 include multiple tuners, one tuner may be used to tune to a television channel on a first transponder stream for display using a television, while another tuner may be used to tune to a television channel on a second transponder for recording and viewing at some other time. If multiple television channels transmitted on the same transponder stream are desired, a single tuner of tuners 315 may be used to receive the signal containing the multiple television channels for presentation and/or recording. Tuners 315 may receive commands from tuning management processor 310-2. Such commands may instruct tuners 315 which frequencies or transponder streams to tune.

Network interface 320 may be used to communicate via an alternate communication channel with a television service provider, if such communication channel is available. The primary communication channel may be via satellite (which may be unidirectional to receiver 300) and the alternate communication channel (which may be bidirectional) may be via a network, such as the Internet. Referring back to FIG. 2, receiver 120-3 may be able to communicate with service provider system 110 via a network, such as the Internet. This communication may be bidirectional: data may be transmitted from receiver 120-3 to service provider system 110 and from service provider system 110 to receiver 120-3. Referring back to FIG. 3, network interface 320 may be configured to communicate via one or more networks, such as the Internet, to communicate with service provider system 110 of FIG. 2. Information may be transmitted and/or received via network interface 320. For instance, data from a television service provider may also be received via network interface 320, if connected with the Internet.

Storage medium 325 may represent one or more non-transitory computer-readable storage mediums. Storage medium 325 may include non-transitory memory and/or a hard drive. Storage medium 325 may be used to store information received from one or more satellites and/or information received via network interface 320. Storage medium 325 may store information related to EPG database 330, gaming metadata 331, DVR database 345, ML model(s) 348, gaming account information 346 and/or gaming application 327. Recorded television programs, which were recorded based on a provider- or user-defined timer may be stored using storage medium 325 as part of DVR database 345. Storage medium 325 may be partitioned or otherwise divided (such as into folders) such that predefined amounts of storage medium 325 are devoted to storage of television programs recorded due to user-defined timers and stored television programs recorded due to provider-defined timers.

EPG database 330 may store information related to television channels and the timing of programs appearing on such television channels. EPG database 330 may be stored using storage medium 325, which may be a hard drive. Information from EPG database 330 may be used to inform users of what television channels or programs are popular and/or provide recommendations to the user. Information from EPG database 330 may provide the user with a visual interface displayed by a television that allows a user to browse and select television channels and/or television programs for viewing and/or recording. Information used to populate EPG database 330 may be received via network interface 320 and/or via satellites, such as satellites 230 of FIG. 2 via tuners 315. For instance, updates to EPG database 330 may be received periodically via satellite. EPG database 330 may serve as an interface for a user to control DVR functions of receiver 300, and/or to enable viewing and/or recording of multiple television channels simultaneously.

Gaming application 327 may be installed as software on all receivers or may be installed based on a request from a television viewer. Gaming application 327, when executed, may cause gaming UI engine 311 to be executed as a process by control processor 310-1 or some other processor of receiver 300. Gaming application 327 may enable bidirectional communication with server system 150 via service provider system 110. Alternatively, gaming application 327 may only present information obtained from gaming server system 150 and communication back to gaming server system 150 may be performed through a separate device, such as mobile device 170. Gaming interface engine 311, when triggered based on user input, may cause a gaming UI to be presented either by itself or simultaneously with television programming being output via television interface 335.

Gaming account information 346 may be or include one or more authorization tokens (e.g., an Oauth token) or a combination of a username and password used by a user to log into the user's gaming account(s). The television viewer may provide his username and password to gaming UI engine 311. This data may be stored and may be used to log into individual ones of the user's gaming accounts when the gaming application is accessed. Gaming metadata 331 may represent temporary sports wagering data obtained from server system 150, such as promotions currently available, wagers currently available, the corresponding odds of such wagers, and/or limits on such wagers. Additionally, some of gaming metadata 331 may be obtained from service provider system 110 (which may, in turn, have obtained the data from content server system 160).

The network information table (NIT) 340 may store information used by receiver 300 to access various television channels. NIT 340 may be stored locally by a processor, such as tuning management processor 310-2 and/or by storage medium 325. Information used to populate NIT 340 may be received via satellite (or cable) through tuners 315 and/or may be received via network interface 320 from the television service provider. As such, information present in NIT 340 may be periodically updated. In some examples, NIT 340 may be locally stored by receiver 300 using storage medium 325. Generally, NIT 340 may store information about a service provider network, such as a satellite-based service provider network. Information that may be present in NIT 340 may include: television channel numbers, satellite identifiers (which may be used to ensure different satellites are tuned to for reception of timing signals), frequency identifiers and/or transponder identifiers for various television channels. In some examples, NIT 340 may contain additional data or additional tables may be stored by the receiver. For example, while specific audio PIDs and video PIDs may not be present in NIT 340, a channel identifier may be present within NIT 340 which may be used to look up the audio PIDs and video PIDs in another table, such as a program map table (PMT). In some examples, a PID associated with the data for the PMT is indicated in a separate table, program association table (PAT), which is not illustrated in FIG. 3. A PAT may be stored by the receiver in a similar manner to the NIT. For example, a PMT may store information on audio PIDs, and/or video PIDs. A PMT stores data on ECM (entitlement control message) PIDs for television channels that are transmitted on a transponder frequency. If, for a first television channel, multiple television channels are to be tuned to, NIT 340 and/or PMT 357 may indicate a second television channel that is to be tuned to when a first channel is tuned to.

Based on information in the NIT, it may be possible to determine the proper satellite and transponder to which to tune for a particular television channel. In some examples, the NIT may list a particular frequency to which to tune for a particular television channel. Once tuned to the proper satellite/transponder/frequency, the PMT PID may be used to retrieve a program management table that indicates the PIDs for audio and video streams of television channels transmitted by that transponder.

While a large portion of storage space of storage medium 325 is devoted to storage of television programming, a portion may be devoted to storage of non-audio/video data, such as EPG database 330. This “other” data may permit receiver 300 to function properly. In some examples, at least ten gigabytes are allocated to such other data. For example, if NIT 340 is stored by storage medium 325, it may be part of other non-video/audio data 326.

Decoder module 333 may serve to convert encoded video and audio into a format suitable for output to a display device. For instance, decoder module 333 may receive MPEG video and audio from storage medium 325 or descrambling engine 365 to be output to a television. MPEG video and audio from storage medium 325 may have been recorded to DVR database 345 as part of a previously recorded television program. Decoder module 333 may convert the MPEG video and audio into a format appropriate to be displayed by a television or other form of display device and audio into a format appropriate to be output from speakers, respectively. Decoder module 333 may have the ability to convert a finite number of television channel streams received from storage medium 325 or descrambling engine 365 simultaneously. For instance, each of decoders 334 within decoder module 333 may be able to only decode a single television channel at a time. While decoder module 333 is illustrated as having three decoders 334 (decoder 334-1, decoder 334-2, and decoder 334-3), in other examples, a greater or fewer number of decoders may be present in receiver 300. A decoder may be able to only decode a single high definition television program at a time.

Television interface 335 may serve to output a signal to a television (or another form of display device) in a proper format for display of video and playback of audio. As such, television interface 335 may output one or more television channels, stored television programming from storage medium 325 (e.g., television programs from DVR database 345, information from EPG database 330) to a television for presentation.

Digital Video Recorder (DVR) functionality may permit a television channel to be recorded for a period of time. DVR functionality of receiver 300 may be managed by control processor 310-1. Control processor 310-1 may coordinate the television channel, start time, and stop time of when recording of a television channel is to occur. DVR database 345 may store information related to the recording of television channels. DVR database 345 may store timers that are used by control processor 310-1 to determine when a television channel should be tuned to and its programs recorded to DVR database 345 of storage medium 325. In some examples, a limited amount of storage medium 325 may be devoted to DVR database 345. Timers may be set by the television service provider and/or one or more users of receiver 300.

DVR database 345 may also be used to record recordings of service provider-defined television channels. For each day, an array of files may be created. For example, based on provider-defined timers, a file may be created for each recorded television channel for a day. For example, if four television channels are recorded from 6-10 PM on a given day, four files may be created (one for each television channel). Within each file, one or more television programs may be present. The service provider may define the television channels, the dates, and the time periods for which the television channels are recorded for the provider-defined timers. The provider-defined timers may be transmitted to receiver 300 via the television provider's network. For example, referring to satellite-based television distribution system 200 of FIG. 2, in a satellite-based service provider system, data necessary to create the provider-defined timers at receiver 120-3 may be received via satellite.

As an example of DVR functionality of receiver 300 being used to record based on provider-defined timers, a television service provider may configure receiver 300 to record television programming on multiple, predefined television channels for a predefined period of time, on predefined dates. For instance, a television service provider may configure receiver 300 such that television programming may be recorded from 7 to 10 PM on NBC, ABC, CBS, and FOX on each weeknight and from 6 to 10 PM on each weekend night on the same channels. These channels may be transmitted as part of a single transponder stream such that only a single tuner needs to be used to receive the television channels. Packets for such television channels may be interspersed and may be received and recorded to a file. If a television program is selected for recording by a user and is also specified for recording by the television service provider, the user selection may serve as an indication to save the television program for an extended time (beyond the time which the predefined recording would otherwise be saved). Television programming recorded based on provider-defined timers may be stored to a portion of storage medium 325 for provider-managed television programming storage.

User input device 350 may include a remote control (physically separate from receiver 300) and/or one or more buttons on receiver 300 that allow a user to interact with receiver 300. User input device 350 may be used to select a television channel for viewing, provide input to gaming UI engine 311, view information from EPG database 330, and/or program a timer stored to DVR database 345, wherein the timer is used to control the DVR functionality of control processor 310-1. In some examples, it may be possible to load some or all of preferences to a remote control. As such, the remote control can serve as a backup storage device for the preferences.

Referring back to tuners 315, television channels received via satellite (or cable) may contain at least some scrambled data. Packets of audio and video may be scrambled to prevent unauthorized users (e.g., nonsubscribers) from receiving television programming without paying the television service provider. When a tuner of tuners 315 is receiving data from a particular transponder of a satellite, the transponder stream may be a series of data packets corresponding to multiple television channels. Each data packet may contain a packet identifier (PID), which, in combination with NIT 340 and/or PMT 357, can be determined to be associated with a particular television channel. Particular data packets, referred to as entitlement control messages (ECMs), may be periodically transmitted. ECMs may be associated with another PID and may be encrypted; receiver 300 may use decryption engine 361 of decryption processing component 360 to decrypt ECMs. Decryption of an ECM may only be possible if the user has authorization to access the particular television channel associated with the ECM. When an ECM is determined to correspond to a television channel being stored and/or displayed, the ECM may be provided to decryption processing component 360 for decryption.

When decryption processing component 360 receives an encrypted ECM, decryption processing component 360 may decrypt the ECM to obtain some number of control words. In some examples, from each ECM received by decryption processing component 360, two control words are obtained. In some examples, when decryption processing component 360 receives an ECM, it compares the ECM to the previously received ECM. If the two ECMs match, the second ECM is not decrypted because the same control words would be obtained. In other examples, each ECM received by decryption processing component 360 is decrypted; however, if a second ECM matches a first ECM, the outputted control words will match; thus, effectively, the second ECM does not affect the control words output by decryption processing component 360. Decryption processing component 360 may be permanently part of receiver 300 or may be configured to be inserted and removed from receiver 300.

Tuning management processor 310-2 may be in communication with tuners 315 and control processor 310-1. Tuning management processor 310-2 may be configured to receive commands from control processor 310-1. Such commands may indicate when to start/stop recording a television channel and/or when to start/stop causing a television channel to be output to a television. Tuning management processor 310-2 may control tuners 315. Tuning management processor 310-2 may provide commands to tuners 315 that instruct the tuners which satellite, transponder, and/or frequency to tune to. From tuners 315, tuning management processor 310-2 may receive transponder streams of packetized data. As previously detailed, some or all of these packets may include a PID that identifies the content of the packet.

Tuning management processor 310-2 may be configured to create one or more PID filters 355 that sort packets received from tuners 315 based on the PIDs. When a tuner is initially tuned to a particular frequency (e.g., to a particular transponder of a satellite), a PID filter may be created based on the PMT data. The PID filter created, based on the PMT data packets, may be known because it is stored as part of NIT 340 or another table, such as a program association table (PAT). From the PMT data packets, PMT may be constructed by tuning management processor 310-2.

PID filters 355 may be configured to filter data packets based on PIDs. In some examples, PID filters 355 are created and executed by tuning management processor 310-2. For each television channel to be output for presentation or recorded, a separate PID filter may be configured. In other examples, separate hardware may be used to create and execute such PID filters. Depending on a television channel selected for recording/viewing, a PID filter may be created to filter the video and audio packets associated with the television channel (based on the PID assignments present in PMT 357). For example, if a transponder data stream includes multiple television channels, data packets corresponding to a television channel that is not desired to be stored or displayed by the user may be ignored by PID filters 355. As such, only data packets corresponding to the one or more television channels desired to be stored and/or displayed may be filtered and passed to either descrambling engine 365 or decryption processing component 360; other data packets may be ignored. For each television channel, a stream of video packets, a stream of audio packets (one or both of the audio programs) and/or a stream of ECM packets may be present, each stream identified by a PID. In some examples, a common ECM stream may be used for multiple television channels. Additional data packets corresponding to other information, such as updates to NIT 340, may be appropriately routed by PID filters 355. At a given time, one or multiple PID filters may be executed by tuning management processor 310-2.

Descrambling engine 365 may use the control words output by decryption processing component 360 in order to descramble video and/or audio corresponding to television channels for storage and/or presentation. Video and/or audio data contained in the transponder data stream received by tuners 315 may be scrambled. Video and/or audio data may be descrambled by descrambling engine 365 using a particular control word. Which control word output by decryption processing component 360 to be used for successful descrambling may be indicated by a scramble control identifier present within the data packet containing the scrambled video or audio. Descrambled video and/or audio may be output by descrambling engine 365 to storage medium 325 for storage (in DVR database 345) and/or to decoder module 333 for output to a television or other presentation equipment via television interface 335.

For simplicity, receiver 300 of FIG. 3 has been reduced to a block diagram; commonly known parts, such as a power supply, have been omitted. Further, some routing between the various modules of receiver 300 has been illustrated. Such illustrations are for exemplary purposes only. The state of two modules not being directly or indirectly connected does not indicate the modules cannot communicate. Rather, connections between modules of the receiver 300 are intended only to indicate possible common data routing. It should be understood that the modules of receiver 300 may be combined into a fewer number of modules or divided into a greater number of modules. Further, the components of receiver 300 may be part of another device, such as built into a television. Any of the interfaces illustrated in the FIGS., or described herein, may be generated by gaming interface engine 311 and output via television interface 335 presentation by a display device, such as television 130.

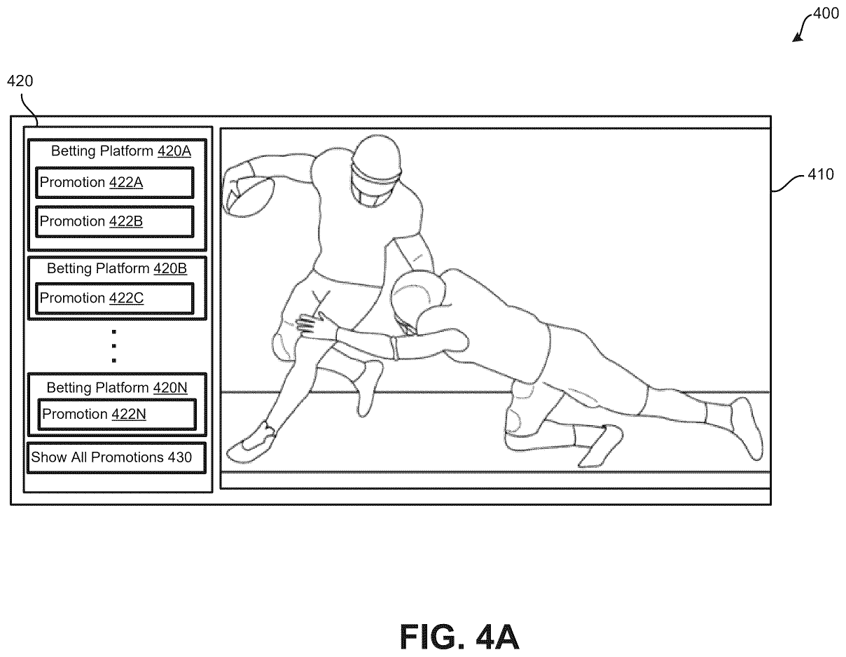

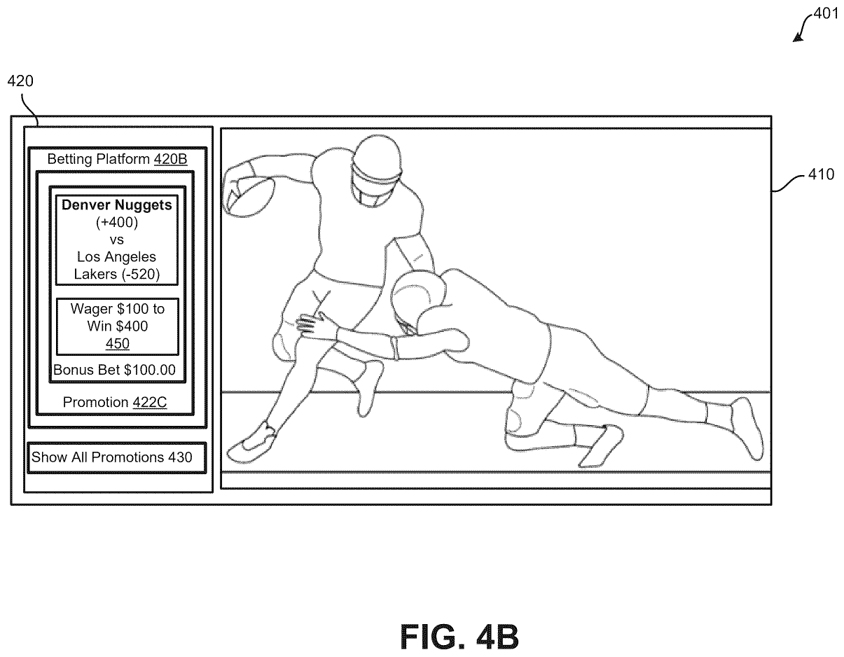

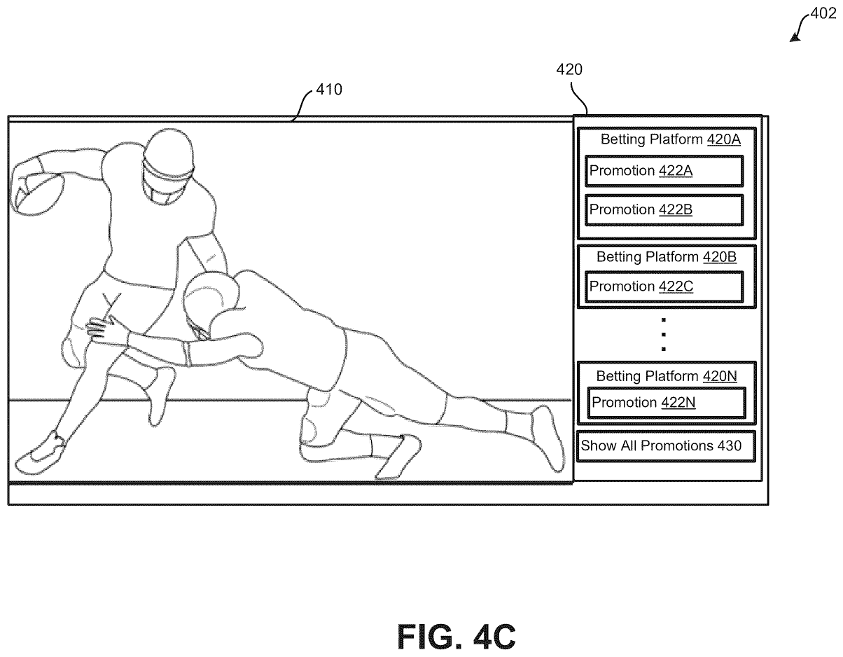

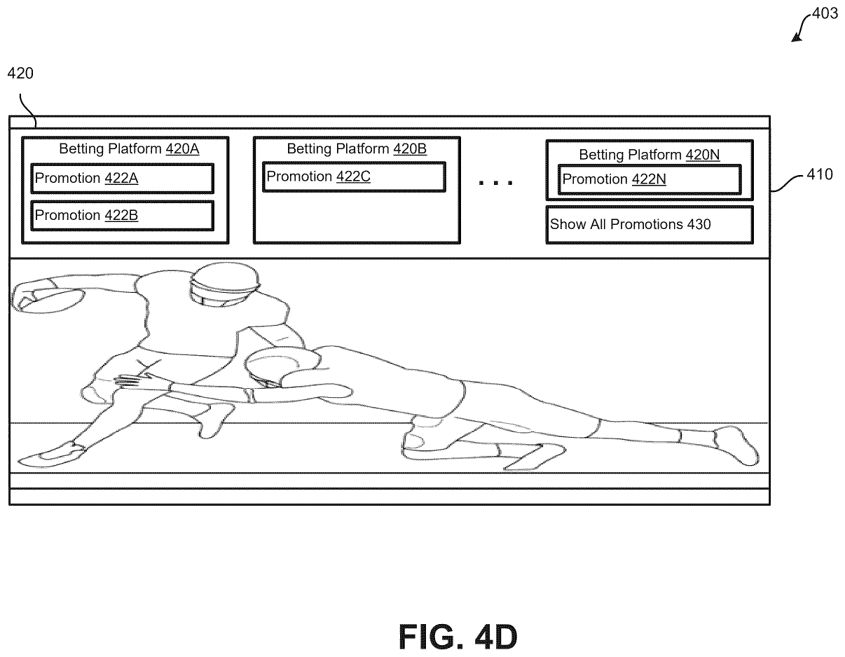

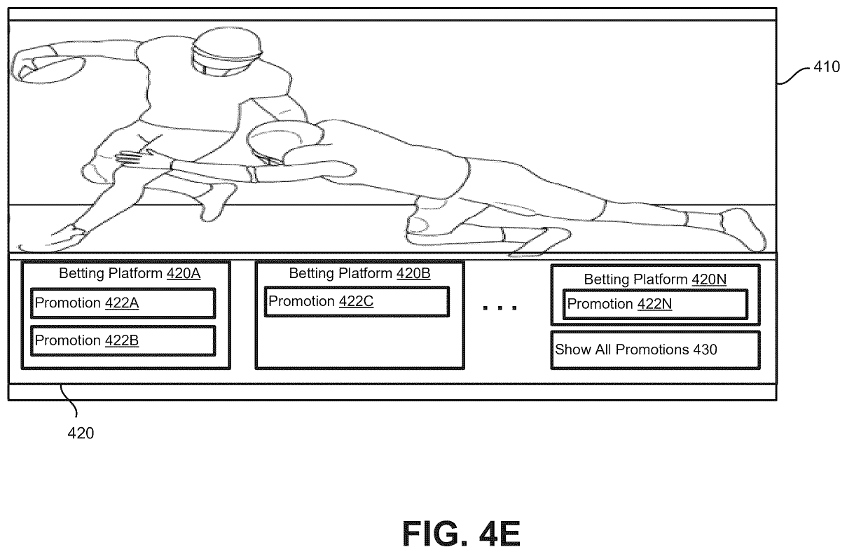

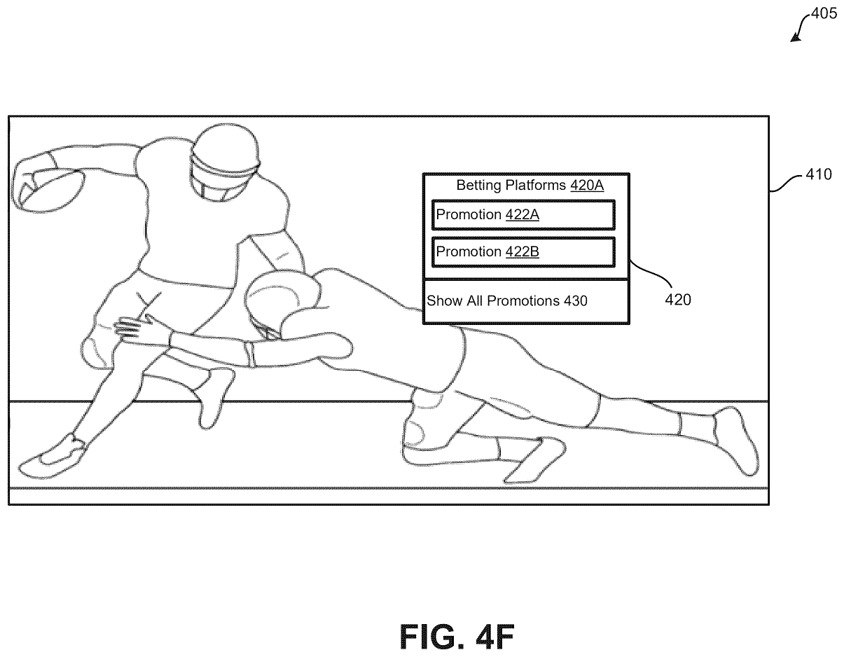

FIG. 4A illustrates a gaming interface 400 (“interface 400”), according to examples. Viewing region 410 may correspond to programming being output by the receiver for a selected channel. For example, a live television channel that was being output when the gaming user interface 420 is displayed may continue to be output in a smaller area to permit room for interface 400 to be presented. In the current example illustrated in FIG. 4A, the gaming user interface 420 is displayed on the left side of the viewing region. In other examples, the gaming user interface can be displayed at other locations. Some of these other locations are illustrated in FIGS. 4C, 4D, 4E, and 4F.

As briefly discussed above, a user/viewer may provide user account information that is securely stored by the service provider system 110. For instance, the viewer may have, during this session or a previous session, provided a username and password for one or more of the accounts the viewer has with one or more betting platforms 180 to gaming interface 400. Alternatively, the username(s) and password(s) may be provided to another server system, such as service provider system 110 and/or gaming server system 150. Based on the username(s) and password(s), the receiver 120 may have retrieved, via service provider system 110 and gaming server system 150, information relating to the television viewer's account(s).

If the viewer desires to potentially participate in a promotion offered by a betting platform 180, the viewer may select one or more of the UI elements 422. When a UI element 422 has been selected, the viewer may then be permitted to interact with more detailed elements corresponding to the selected promotion. For instance, individual elements regarding teams, the spread, the over/under, or payouts on a wager may not be eligible to be selected until the viewer selects the UI element 422. Further details provided in relation to FIG. 4B when element 422 has been selected.

FIG. 4B illustrates an example of a gaming interface 401 in which a viewer can confirm participation in the selected promotion. For interface 400 of FIG. 4A, assume that the viewer has selected UI element 422C available from betting platform 420B. After element 422C has been selected, the viewer may be permitted to confirm betting on the promotion and/or specify different options (e.g., select teams, players, points, . . . ) that are associated with the promotion. In the current example, UI element 422C is associated with a bonus bet promotion of $100 available from betting platform 420B. For purposes of explanation, assume that the user has selected to place the $100 bonus bet on the Denver Nuggets wining against the LA Lakers. Referring to UI 450, the UI element 422C includes information about the promotion and a selectable UI element 450 to confirm the selections. If the viewer decides to place this bonus bet, the viewer can select UI element 450.

In other examples, the viewer may input details and confirmation of the bonus bet via the mobile device. For instance, selecting UI element 422C can trigger transmission of the promotion to a mobile device of the television viewer. As previously detailed, transmission of a promotion/wager may be sent to the mobile device communication with service provider system 110, which relays the promotions/wagers to gaming server system 150, which, in turn, sends a link or notification to mobile device 170. Alternatively, a machine-readable code may be presented that can be imaged by mobile device 170. The machine-readable code may have the wagers encoded or the machine readable-code may allow the wagers to be retrieved from gaming server system 150.

FIG. 4C illustrates a gaming interface 402 (“interface 402”), according to examples. Viewing region 410 may correspond to programming being output by the receiver for a selected channel. For example, a live television channel that was being output when the gaming user interface 420 is displayed may continue to be output in a smaller area to permit room for interface 400 to be presented. In the current example illustrated in FIG. 4C, the gaming user interface 420 is displayed on the right side of the viewing region.

FIG. 4D illustrates a gaming interface 403 (“interface 400”), according to examples. Viewing region 410 may correspond to programming being output by the receiver for a selected channel. For example, a live television channel that was being output when the gaming user interface 420 is displayed may continue to be output in a smaller area to permit room for interface 400 to be presented. In the current example illustrated in FIG. 4D, the gaming user interface 420 is displayed above the viewing region.

FIG. 4E illustrates a gaming interface 404 (“interface 404”), according to examples. Viewing region 410 may correspond to programming being output by the receiver for a selected channel. For example, a live television channel that was being output when the gaming user interface 420 is displayed may continue to be output in a smaller area to permit room for interface 400 to be presented. In the current example illustrated in FIG. 4E, the gaming user interface 420 is displayed below the viewing region.

FIG. 4F illustrates a gaming interface 405 (“interface 405”), according to examples. Viewing region 410 may correspond to programming being output by the receiver for a selected channel. For example, a live television channel that was being output when the gaming user interface 420 is displayed may continue to be output in a smaller area to permit room for interface 400 to be presented. In the current example illustrated in FIG. 4F, the gaming user interface 420 is displayed at a user selected location within the viewing region. According to some configurations, a user may configure where the gaming user interface is to be displayed and/or what UI elements are included within the gaming user interface

FIG. 5 illustrates an example of a gaming user interface 500 in which a promotion has been sent to the television viewer's mobile device. Interface 500 may be presented following the viewer selecting the promotion to be sent to the mobile device 170 of the viewer. Notification 530 may be presented to indicate that one or more promotions/wagers have been successfully transmitted to the mobile device of the viewer.

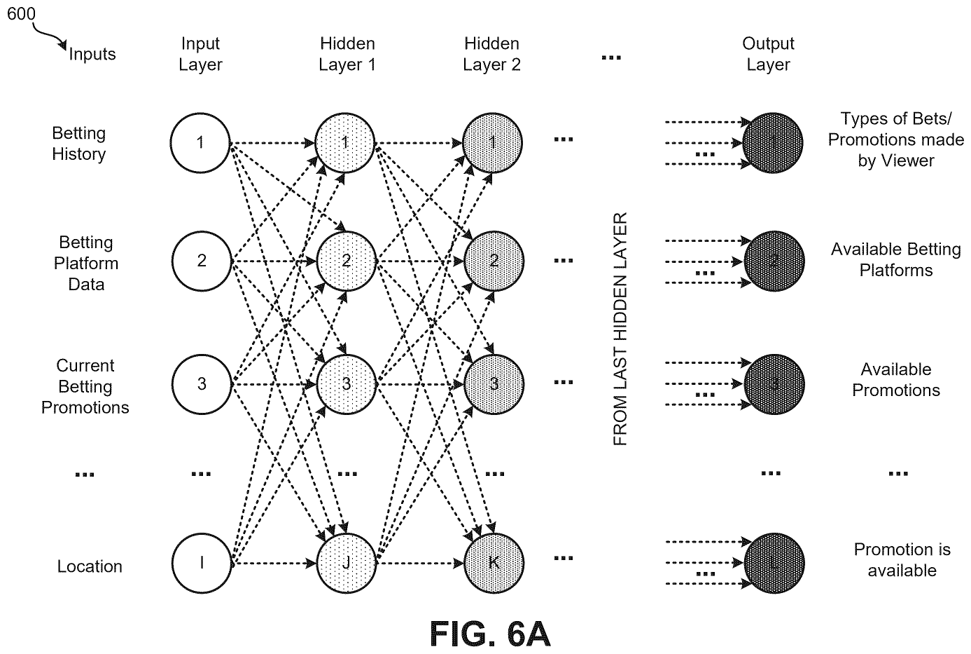

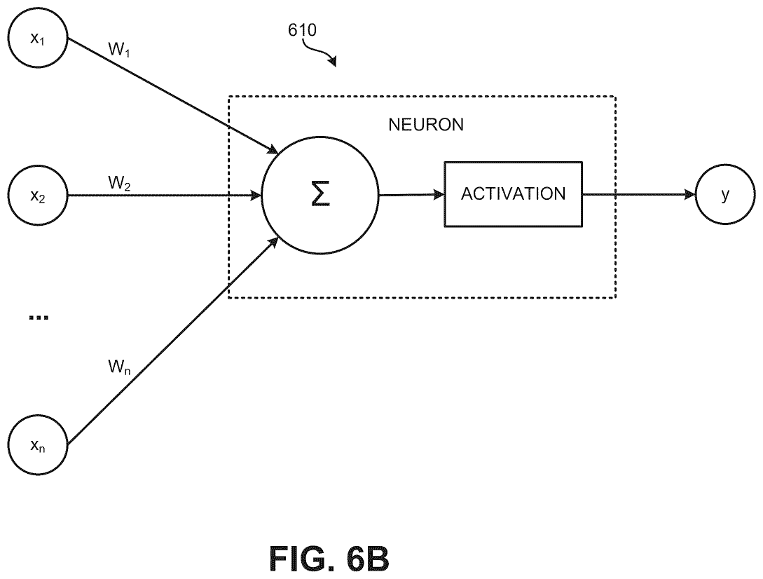

FIG. 6A illustrates an example of a neural network 600 that has been trained to generate a recommendation of one or more promotions to include within a gaming user interface, according to various example of the present disclosure. The neural network 600 may be a GAN and include a number of hidden layers. Both deep learning neural networks (DLNNs) and shallow learning neural networks (SLNNs) usually have multiple layers, although SLNNs may only have one or two layers in some cases, and normally fewer than DLNNs. Typically, the neural network architecture includes an input layer, multiple intermediate layers, and an output layer, as is the case in neural network 600.

A DLNN often has many layers (e.g., 10, 50, 200, etc.) and subsequent layers typically reuse features from previous layers to compute more complex, general functions. A SLNN, on the other hand, tends to have only a few layers and train relatively quickly since expert features are created from raw data samples in advance. However, feature extraction is laborious. DLNNs, on the other hand, usually do not require expert features, but tend to take longer to train and have more layers. For both approaches, the layers are trained simultaneously on the training set, normally checking for overfitting on an isolated cross-validation set. Both techniques can yield excellent results, and there is considerable enthusiasm for both approaches. The optimal size, shape, and quantity of individual layers varies depending on the problem that is addressed by the respective neural network.

As illustrated in FIG. 6A, various parameters related to promotions and betting (e.g., parameters relating to past betting history), betting platforms, current betting promotions, location where promotions are available, and the like are provided as the input layer are fed as inputs to the J neurons of hidden layer 1. While all of these inputs are fed to each neuron in this example, various architectures are possible that may be used individually or in combination including, but not limited to, feed forward networks, radial basis networks, deep feed forward networks, deep convolutional inverse graphics networks, convolutional neural networks, recurrent neural networks, artificial neural networks, long/short term memory networks, gated recurrent unit networks, generative adversarial networks (GANs), liquid state machines, auto encoders, variational auto encoders, denoising auto encoders, sparse auto encoders, extreme learning machines, echo state networks, Markov chains, Hopfield networks, Boltzmann machines, restricted Boltzmann machines, deep residual networks, Kohonen networks, deep belief networks, deep convolutional networks, support vector machines, neural Turing machines, or any other suitable type or combination of neural networks without deviating from the scope of the invention.

Hidden layer 2 receives inputs from hidden layer 1, hidden layer 3 receives inputs from hidden layer 2, and so on for all hidden layers until the last hidden layer provides its outputs as inputs for the output layer. It should be noted that numbers of neurons I, J, K, and L are not necessarily equal, and thus, any desired number of layers may be used for a given layer of neural network 400 without deviating from the scope of the present disclosure. Indeed, in certain examples, the types of neurons in a given layer may not all be the same.

It should be noted that neural networks are probabilistic constructs that typically have confidence score(s). This may be a score learned by the ML model based on how often a similar input was correctly identified during training. Some common types of confidence scores include a decimal number between 0 and 1 (which can be interpreted as a confidence percentage as well), a number between negative co and positive co, a set of expressions (e.g., “low,” “medium,” and “high”), etc. Various post-processing calibration techniques may also be employed in an attempt to obtain a more accurate confidence score, such as temperature scaling, batch normalization, weight decay, negative log likelihood (NLL), etc.

“Neurons” in a neural network are implemented algorithmically as mathematical functions that are typically based on the functioning of a biological neuron. Neurons receive weighted input and have a summation and an activation function that governs whether they pass output to the next layer. This activation function may be a nonlinear thresholded activity function where nothing happens if the value is below a threshold, but then the function linearly responds above the threshold (i.e., a rectified linear unit (ReLU) nonlinearity). Summation functions and ReLU functions are used in deep learning since real neurons can have approximately similar activity functions. Via linear transforms, information can be subtracted, added, etc. In essence, neurons act as gating functions that pass output to the next layer as governed by their underlying mathematical function. In some examples, different functions may be used for at least some neurons.

An example of a neuron 610 is shown in FIG. 6B. Inputs X₁, X₂, . . . , Xₙ, from a preceding layer are assigned respective weights W₁, W₂, . . . , Wₙ. Thus, the collective input from preceding neuron 1 is WᵢXᵢ. These weighted inputs are used for the neuron's summation function modified by a bias, such as:

$${\sum }_{i = 1}^{m} ( {W}_{i} {X}_{i} ) + bias \qquad ( 1 )$$

This summation is compared against an activation function f(x) to determine whether the neuron “fires”. For instance, f(x) may be given by

$$f ( X ) = \{ \begin{matrix}1 if {\sum }_{i = 1}^{m} ( {W}_{i} {X}_{i} ) + bias \geq 0 \\ 0 if {\sum }_{i = 1}^{m} ( {W}_{i} {X}_{i} ) + bias < 0\end{matrix} \qquad ( 2 )$$

The output y of neuron 310 may thus be given by:

$$y = f ( X ) {\sum }_{i = 1}^{m} ( {W}_{i} {X}_{i} ) + bias \qquad ( 3 )$$

In this case, neuron 610 is a single-layer perceptron. However, any suitable neuron type or combination of neuron types may be used without deviating from the scope of the invention. It should also be noted that the ranges of values of the weights and/or the output value(s) of the activation function may differ in some examples without deviating from the scope of the present disclosure.

The goal, or “reward function” is often employed, such as for this selecting the best devices to perform the task or the requested task. A reward function explores intermediate transitions and steps with both short-term and long-term rewards to guide the search of a state space and attempt to achieve a goal (e.g., determining when the network is likely to be congested, identifying the optimal bitrate, etc.).

During training, various labeled data (e.g., betting data, betting platforms, promotions, . . . ) are fed through neural network 600. Successful identifications strengthen weights for inputs to neurons, whereas unsuccessful identifications weaken them. A cost function, such as mean square error (MSE) or gradient descent may be used to punish predictions that are slightly wrong much less than predictions that are very wrong. If the performance of the ML model is not improving after a certain number of training iterations, the reward function may be modified to provide corrections of incorrect predictions, etc.

Backpropagation is a technique for optimizing synaptic weights in a feedforward neural network. Backpropagation may be used to “pop the hood” on the hidden layers of the neural network to see how much of the loss every node is responsible for, and subsequently updating the weights in such a way that minimizes the loss by giving the nodes with higher error rates lower weights, and vice versa. In other words, backpropagation allows data scientists to repeatedly adjust the weights so as to minimize the difference between actual output and desired output.

The backpropagation algorithm is mathematically founded in optimization theory. In supervised learning, training data with a known output is passed through the neural network and error is computed with a cost function from known target output, which gives the error for backpropagation. Error is computed at the output, and this error is transformed into corrections for network weights that will minimize the error.

In the case of supervised learning, an example of backpropagation is provided below. A column vector input x is processed through a series of N nonlinear activity functions fᵢ between each layer i=1, . . . , N of the network, with the output at a given layer first multiplied by a synaptic matrix Wᵢ, and with a bias vector bi added. The network output o, given by:

$$o = {f}_{N} ( {W}_{N} {f}_{N - 1} ( {W}_{N - 1} {f}_{N - 2} ( … {f}_{1} ( {W}_{I} X + {b}_{1} ) … ) + {b}_{N - 1} ) + {b}_{N} ) \qquad ( 4 )$$

In some examples, o is compared with a target output t, resulting in an error (E), which is expressed below and desired to be minimized:

$$E = \frac{1}{2} {‖ 0 - t ‖}^{2} \qquad ( 5 )$$

Optimization in the form of a gradient descent procedure may be used to minimize the error by modifying the synaptic weights Wᵢ for each layer. The gradient descent procedure requires the computation of the output o given an input x corresponding to a known target output t, and producing an error (o-t). This global error is then propagated backwards giving local errors for weight updates with computations similar to, but not exactly the same as, those used for forward propagation. In particular, the backpropagation step typically requires an activity function of the form pⱼ(nⱼ)=fⱼ′(nⱼ), where nⱼ is the network activity at layer j (i.e., nⱼ=Wⱼoⱼ₋₁+bⱼ) where oⱼ=fⱼ(nⱼ) and the apostrophe ' denotes the derivative of the activity function f.

The weight updates may be computed via the formulae:

$${d}_{j} = \{ \begin{matrix}( o − t ) ∘ {p}_{j} ( {n}_{j} ) , j = N \\ {W}_{j = 1}^{T} {d}_{j + 1} ∘ {p}_{j} ( {n}_{j} ) , j < N\end{matrix} \qquad ( 6 )$$

$$\frac{\partial E}{\partial {W}_{j + 1}} = {{d}_{j + 1} ( {o}_{j} )}^{T} \qquad ( 7 )$$

$$\frac{\partial E}{\partial {b}_{j + 1}} = {d}_{j + 1} \qquad ( 8 )$$

$${W}_{j}^{n e w} = {W}_{j}^{o l d} - η \frac{\partial E}{\partial {W}_{j}} \qquad ( 9 )$$

$${b}_{j}^{n e w} = {b}_{j}^{o l d} - η \frac{\partial E}{\partial {b}_{j}} \qquad ( 10 )$$

where ∘ denotes a Hadamard product (i.e., the element-wise product of two vectors), T denotes the matrix transpose, and oⱼ denotes fⱼ(Wⱼoⱼ₋₁+bⱼ), with o₀=X. Here, the learning rate n is chosen with respect to machine learning considerations. Below, η is related to the neural Hebbian learning mechanism used in the neural implementation. Note that the synapses W and b can be combined into one large synaptic matrix, where it is assumed that the input vector has appended ones, and extra columns representing the b synapses are subsumed to W.

The ML model 114 may be trained over multiple epochs until it reaches a good level of accuracy (e.g., 97% or better using an F2 or F4 threshold for detection and approximately 2,000 epochs). This accuracy level may be determined in some examples using an F1 score, an F2 score, an F4 score, or any other suitable technique without deviating from the scope of the invention. Once trained on the training data, the ML model may be tested on a set of evaluation data that the ML model has not encountered before. This helps to ensure that the ML model is not “over fit” such that it performs well on the training data, but does not perform well on other data.

In some examples, it may not be known what accuracy level is possible for the ML model to achieve. Accordingly, if the accuracy of the ML model is starting to drop when analyzing the evaluation data (i.e., the model is performing well on the training data, but is starting to perform less well on the evaluation data), the ML model may go through more epochs of training on the training data (and/or new training data). In some examples, the ML model is only deployed if the accuracy reaches a certain level or if the accuracy of the trained ML model is superior to an existing deployed ML model. In certain examples, a collection of trained ML models may be used to accomplish a task. This may collectively allow the ML models to enable semantic understanding to better predict event-based congestion or service interruptions due to an accident, for instance.

In some examples, transformer networks may be used. Examples of the transformer network includes SentenceTransformers™, which is a Python™ framework for state-of-the-art sentence, text, and image embeddings. Such transformer networks learn associations of words and phrases that have both high scores and low scores. This trains the ML model to determine what is close to the input and what is not, respectively. Rather than just using pairs of words/phrases, transformer networks may use the field length and field type, as well.

Natural language processing (NLP) techniques such as word2vec, BERT, GPT-3.5, etc. may be used in some examples to facilitate semantic understanding. Other techniques, such as clustering algorithms, may be used to find similarities between groups of elements. Clustering algorithms may include, but are not limited to, density-based algorithms, distribution-based algorithms, centroid-based algorithms, hierarchy-based algorithms. K-means clustering algorithms, the DB SCAN clustering algorithm, the Gaussian mixture model (GMM) algorithms, the balance iterative reducing and clustering using hierarchies (BIRCH) algorithm, etc. Such techniques may also assist with categorization.

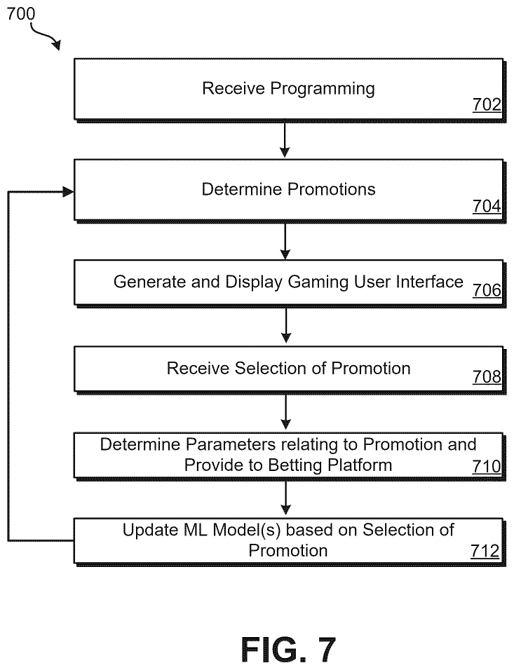

FIG. 7 is a flow diagram illustrating a process 700 for determining and displaying promotions based on betting history, according to an example.

At 702, programming is received. As discussed above, the programming may be television programming received from a service provider system. In some examples, the programming is received by a receiver 120 that displays the programming on a display device, such as television 130.

At 704, the promotions to display are determined. In some examples, a gaming manager 112 uses one or more ML models 114 to identify promotions that are currently available from one or more betting platforms 180 to display to the viewer. In some examples, the past betting history of the viewer (e.g., past bets, participation in similar promotions, . . . ) is used by the ML model(s) 114 to identify promotions that the viewer would be interested in participating. In some examples, the gaming manager 112 accesses promotions available from each of the betting platforms that the viewer has an account with and uses the one or more ML models 114 to determine the current betting promotions that are likely to be wagered on by the view.

At 706, the gaming UI 122 is generated and displayed. As discussed above, in some examples, viewer 101 may, via the gaming UI output by receiver 120-3 on a display device, such as television 130. In some examples, the viewer can trigger one or more wagers/promotions to be transmitted to mobile device 170. In such examples, the gaming UI 122 executed by receiver 120-3 may be used to communicate with service provider system 110 and/or betting platform(s) 180. In some examples, the gaming UI may communicate information that indicates a selected promotion that the viewer 101 would like to wager on. Service provider system 110 can relay this information to a gaming server system 150 via network 140. Alternatively, the gaming UI 122 may use an application programming interface (API) to relay an indication of the one or more wagers/promotions to the gaming server system 150 (without communicating through service provider system 110). Gaming server system 150 may then be triggered to transmit a link or notification to mobile device 170.

At 708, a selection of a promotion is received. As discussed above, in some examples, the viewer may select (e.g., via a remote control associated with the receiver and/or some other device that can select a UI element associated with a displayed promotion) a displayed promotion. According to some configurations, the gaming UI 122 communicates information that indicates a selected promotion that the viewer 101 would like to wager on. Service provider system 110 can relay this information to a gaming server system 150 via network 140. Alternatively, the gaming UI 122 may use an application programming interface (API) to relay an indication of the one or more wagers/promotions to the gaming server system 150 (without communicating through service provider system 110). Gaming server system 150 may then be triggered to transmit a link or notification to mobile device 170.

At 710, the parameters relating to the selected promotion are determined and provided to the betting platform. As discussed above, in some examples, the viewer may select/specify different parameters (e.g., teams, players, bet amount, . . . ) that is associated with a selected promotion. Once specified, the parameters relating to the selected promotion are provided to the betting platform.

At 712, the one or more ML models can be updated based on the selection of a promotion. As discussed above, the one or more ML models can be updated based on the updated betting history associated with the viewer and/or other similar viewers.

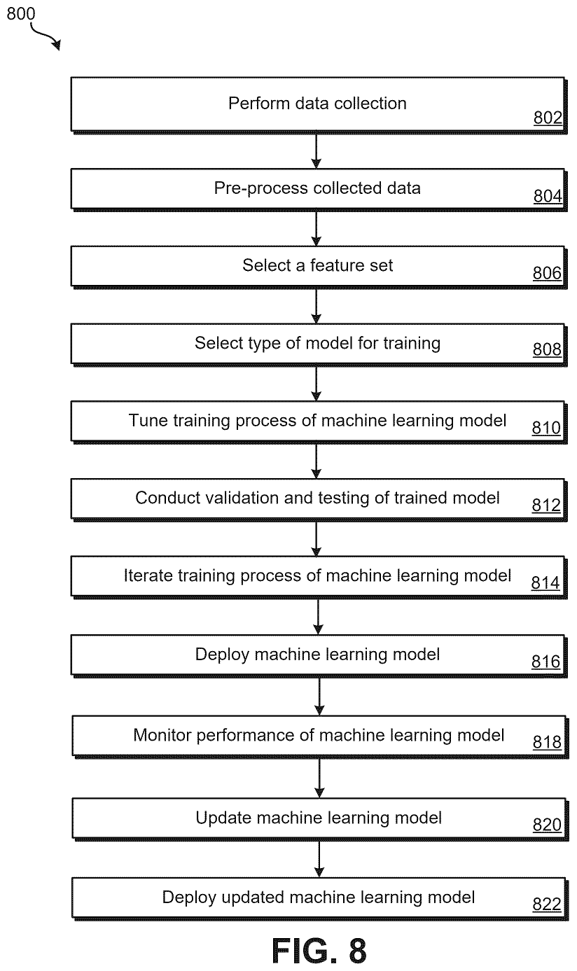

FIG. 8 a flow diagram illustrating a process 800 for training and updating one or more ML models for use in configurations disclosed herein. Once trained, the trained ML model may be used. For example, at process block 704 referenced above with respect to FIG. 7. In some examples, the trained ML model may be updated over time (e.g., see process block 712 of FIG. 7) and deployed for use.

Prior to discussion of method 800, an overview of a machine learning process, including inputs and outputs given to a machine learning model, is provided. The machine learning and training process may include any of the following features or methods for training. In some examples, supervised learning models may be used. In this example, models may be trained on a labeled dataset. For instance, each training example for the machine learning model may be paired with an output label. In the training process, the model learns to predict an output from an input set of data. Examples may include linear regression for continuous outputs and logistic regression, support vector machines (SVMs), and neural networks for categorical outputs. Additional examples may include unsupervised learning models. Such models work with unlabeled data. Techniques which may be used include clustering (e.g., k-means, hierarchical clustering) and dimensionality reduction (e.g., principal component analysis, auto-encoders, etc.). Other examples may include semi-supervised learning processes. This involves a combination of a small amount of labeled data and a large amount of unlabeled data. The model leverages the labeled data to learn better representations of the unlabeled data, improving its performance.

In some examples, reinforcement learning techniques may be used. In some examples, models may be trained or “learn” to make sequences of decisions by interacting with an environment to achieve a goal. The learning is guided by rewards, where the model seeks to maximize its total reward. Examples include game playing, robotic navigation, and online recommendation systems.

In some examples, additional types of machine learning models, techniques, or training methods may be used. In some examples, a Recurrent Neural Network (RNN) may be used. A Recurrent Neural Network (RNN) is a class of artificial neural networks where connections between nodes form a directed graph along a temporal sequence. This structure allows RNNs to exhibit temporal dynamic behavior and to process sequences of inputs. This makes them particularly suitable for applications where the time aspect of data is useful. RNN architecture involves a layer of neurons that are connected in a loop, allowing information to persist. Variants of the RNN network, including Long Short-Term Memory (LSTM) may be used. LSTM is designed to overcome a problem of a vanishing gradient in RNNs and is capable of achieving learning long-term dependencies. Gated Recurrent Units, which are a simplified version of LSTMs may also be used. GRUs use a different gating mechanism than LSTMs and are effective at capturing long-term dependencies.

Convolutional Neural Networks (CNNs) are a specialized kind of Deep Neural Networks. CNNs are composed of multiple layers that transform the input volume (such as an image) into an output volume (e.g., class scores) through a series of differentiable operations.

At 802, data collection can be performed that is used to train a machine learning model. In some examples, the data collection is associated with past betting history data, and/or other data relating to betting and promotions. This information may be based on historical data or a set of training or testing data.

At 804, the collected data may be pre-processed. This may include normalization of the data, removing or reducing data with high correlation, or simplifying or removing certain types of data. The removal of certain types of data or simplification may be useful for the purpose of training. Simplification of certain types of data may improve performance of the machine learning model.

At 806, a feature set may be selected. This may include the features or set of features which are most relevant to the determining of betting promotions to display to the viewer. Any subset of features may be also selected at this block. In some examples, multiple feature sets may be selected for training. The feature set which is determined to be most significant may later be selected.

At 808, a type of ML model may be selected for training. This may include classification models, regression models, or neural networks. In some examples, multiple neural networks may be chosen and trained and tested for predictive accuracy. This may include neural networks with varying numbers of intermediate layers or hidden layers. The number of nodes in each layer, including the input layer, output layer, and hidden layers may also be varied in choosing a suitable machine learning model. In some examples, the neural network may be chosen based on accuracy for a subset of training data which is thought to be most common. In some examples, iterative and non-iterative processes described above may be used to determine or generate training data for training a model. In some examples, multiple models may be selected for training.

At 810, tuning of the training process or model may take place. Tuning may include changing or adjusting hyperparameters. A hyperparameter is a parameter, such as the learning rate or choice of optimizer, which specifies details of the learning process. This may include finding the best configuration of hyperparameters which maximizes the predictive accuracy and minimizes the error on a validation dataset.

At 812, validation and testing may take place. This may include validating the trained model on a separate dataset which is not used to train to model to evaluate the model's performance.

At 814, the training process may be iterated by enhancing the training dataset. This may include providing additional data, selecting different features or parameters to train the model, selecting a new algorithm or training method, or changing features of a neural network. Additionally, the model may be monitored and retrained based on new data which is received.

At 816, the ML can be deployed. Once the ML model is deployed, the gaming manager 112 can use the ML model to determine the promotions to display to the viewer.

At 818, after deployment, the gaming manager 112, or some other device/component can monitor the performance of the ML model to ensure it meets the expected improvement metrics. Feedback on its performance can be collected continuously.

At 820, the ML model can be updated to increase the performance of the ML model. If areas of improvement or dissatisfaction are identified, these insights, and additional training data, can trigger a new cycle of updates, starting again from 802.

At 822, the updated ML model can be deployed.

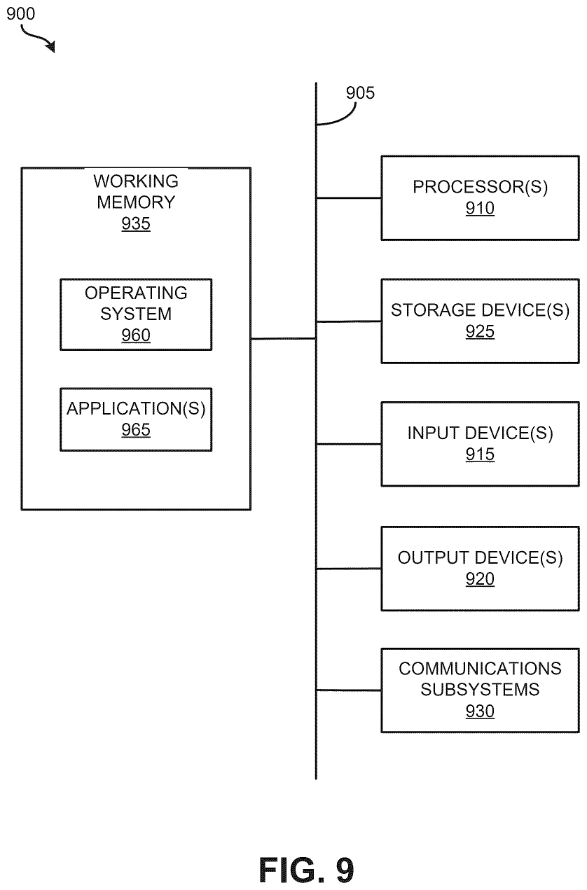

FIG. 9 provides a schematic illustration of one example of a computer system 900 that can perform some or all of the steps of the methods and workflows provided by various examples. It should be noted that FIG. 9 is meant only to provide a generalized illustration of various components, any or all of which may be utilized as appropriate. FIG. 9, therefore, broadly illustrates how individual system elements may be implemented in a relatively separated or relatively more integrated manner.

The computer system 900 is shown including hardware elements that can be electrically coupled via a bus 905, or may otherwise be in communication, as appropriate. The hardware elements may include one or more processors 910, including without limitation one or more general-purpose processors and/or one or more special-purpose processors such as digital signal processing chips, graphics acceleration processors, and/or the like; one or more input devices 915, which can include without limitation a mouse, a keyboard, a camera, and/or the like; and one or more output devices 920, which can include without limitation a display device, a printer, and/or the like.

The computer system 900 may further include and/or be in communication with one or more non-transitory storage devices 925, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 900 might also include a communications subsystem 930, which can include without limitation a modem, a network card (wireless or wired), an infrared communication device, a wireless communication device, and/or a chipset such as a Bluetooth™ device, a 802.11 device, a WiFi device, a WiMax device, cellular communication facilities, etc., and/or the like. The communications subsystem 930 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 930. In other examples, a portable electronic device, e.g., the first electronic device, may be incorporated into the computer system 900, e.g., an electronic device as an input device 915. In some examples, the computer system 900 will further include a working memory 935, which can include a RAM or ROM device, as described above.

The computer system 900 also can include software elements, shown as being currently located within the working memory 935, including an operating system 960, device drivers, executable libraries, and/or other code, such as one or more application programs 965, which may include computer programs provided by various examples, and/or may be designed to implement methods, and/or configure systems, provided by other examples, as described herein. Merely by way of example, one or more procedures described with respect to the methods discussed above, such as those described in relation to FIG. 8, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 925 described above. In some cases, the storage medium might be incorporated within a computer system, such as computer system 900. In other examples, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 900 and/or might take the form of source and/or installable code, which, upon compilation and/or installation on the computer system 900 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some examples may employ a computer system such as the computer system 900 to perform methods in accordance with various examples of the technology. According to a set of examples, some or all of the operations of such methods are performed by the computer system 900 in response to processor 910 executing one or more sequences of one or more instructions, which might be incorporated into the operating system 960 and/or other code, such as an application program 965, contained in the working memory 935. Such instructions may be read into the working memory 935 from another computer-readable medium, such as one or more of the storage device(s) 925. Merely by way of example, execution of the sequences of instructions contained in the working memory 935 might cause the processor(s) 910 to perform one or more procedures of the methods described herein. Additionally, or alternatively, portions of the methods described herein may be executed through specialized hardware.

The terms “machine-readable medium” and “computer-readable medium,” as used herein, refer to any medium that participates in providing data that causes a machine to operate in a specific fashion. In an example implemented using the computer system 900, various computer-readable media might be involved in providing instructions/code to processor(s) 910 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 925. Volatile media include, without limitation, dynamic memory, such as the working memory 935.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 910 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 900.

The communications subsystem 930 and/or components thereof generally will receive signals, and the bus 905 then might carry the signals and/or the data, instructions, etc. carried by the signals to the working memory 935, from which the processor(s) 910 retrieves and executes the instructions. The instructions received by the working memory 935 may optionally be stored on a non-transitory storage device 925 either before or after execution by the processor(s) 910.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Various aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms “a”, “an”, and “the” include plural references unless the context clearly dictates otherwise. Thus, for example, reference to “a segment” includes a plurality of such segments, and reference to “the processor” includes reference to one or more processors and equivalents thereof known in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

As used herein, “media content,” “media program,” “multimedia content,” “content,” or variants thereof should be understood as referring to any audiovisual programming or content in any streaming, file-based, or another format. The media content generally includes data that, when processed by a media player or decoder, allows the media player or decoder to present a visual and/or audio representation of the corresponding program content to a viewer (i.e., the user of a client device including the media player or decoder). In one or more examples, a media player can be realized as a piece of software that plays multimedia content (e.g., displays video and plays audio).

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for presenting betting promotions, comprising:
generating, by one or more processors, a gaming user interface (UI) that includes one or more UI elements that indicate one or more promotions available from one or more betting platforms that are individually selectable, wherein the one or more promotions are based on betting history data associated with a viewer of the gaming UI;
causing, by the one or more processors, the gaming UI to be presented on a display concurrently with programming received from a service provider system;
receiving, by the one or more processors, a selection of a promotion from the one or more promotions, wherein the promotion is associated with a betting platform from the one or more betting platforms; and
transmitting, by the one or more processors, an indication of the selection of the promotion to one or more of the service provider system or the betting platform.

2. The method of claim 1, further comprising determining the one or more promotions using one or more machine learning (ML) models that analyze at least a portion of the betting history data.

3. The method of claim 2, further comprising:
updating at least one of the one or more ML models to create an updated ML model using at least the selection of the promotion as a training input; and
deploying the updated ML model.

4. The method of claim 1, further comprising authenticating the viewer of the gaming UI, wherein authenticating the viewer includes determining that the viewer is authorized to participate in the one or more promotions available from the one or more betting platforms.

5. The method of claim 1, wherein receiving the selection of the promotion, comprises receiving the selection via a remote control associated with a receiver that receives the programming from the service provider system.

6. The method of claim 1, further comprising causing a link to a wagering transaction to be transmitted from the betting platform to a mobile device of the viewer.

7. The method of claim 6, further comprising:
accessing, via the mobile device, the wagering transaction using the link; and
initiating, via the mobile device, the wagering transaction.

8. The method of claim 6, wherein accessing the wagering transaction comprises an application installed on the mobile device being launched in response to the link being accessed.

9. A system, comprising:
one or more processors configured to:
receive programming from a service provider system;
output, to a display, the programming;
generate a gaming user interface (UI) that includes one or more UI elements that indicate one or more promotions available from one or more betting platforms that are individually selectable, wherein the one or more promotions are based on betting history data associated with a viewer of the gaming UI;
cause the gaming UI to be presented on the display concurrently with the programming;
receive a selection of a promotion from the one or more promotions, wherein the promotion is associated with a betting platform from the one or more betting platforms; and
transmit an indication of the selection of the promotion to one or more of the service provider system or the betting platform.

10. The system of claim 9, wherein the one or more processors are further configured to determine the one or more promotions using one or more machine learning (ML) models that analyze at least a portion of the betting history data.

11. The system of claim 10, wherein the one or more processors are further configured to:
update at least one of the one or more ML models to create an updated ML model using at least the selection of the promotion as a training input; and
deploy the updated ML model.

12. The system of claim 9, wherein the one or more processors are further configured to authenticate the viewer of the gaming UI, wherein authenticating the viewer includes determining that the viewer is authorized to participate in the one or more promotions available from the one or more betting platforms.

13. The system of claim 9, wherein receiving the selection of the promotion, comprises receiving the selection via a remote control associated with a receiver that receives the programming from the service provider system.

14. The system of claim 9, further comprising causing a link to a wagering transaction to be transmitted from the betting platform to a mobile device of the viewer.

15. The system of claim 14, wherein the one or more processors are further configured to:
access, via the mobile device, the wagering transaction using the link; and
initiate, via the mobile device, the wagering transaction.

16. The system of claim 15, wherein accessing the wagering transaction comprises an application installed on the mobile device being launched in response to the link being accessed.

17. A non-transitory computer-readable storage media storing computer-executable instructions that when executed by the one or more processors, cause the one or more processors to:
generate a gaming user interface (UI) that includes one or more UI elements that indicate one or more promotions available from one or more betting platforms that are individually selectable, wherein the one or more promotions are based on betting history data associated with a viewer of the gaming UI;
cause the gaming UI to be presented on a display concurrently with programming received from a service provider system;
receive a selection of a promotion from the one or more promotions, wherein the promotion is associated with a betting platform from the one or more betting platforms; and
transmit an indication of the selection of the promotion to one or more of the service provider system or the betting platform.

18. The non-transitory computer-readable storage media of claim 17, wherein the computer-executable instructions when executed, cause the one or more processors to determine the one or more promotions using one or more machine learning (ML) models that analyze at least a portion of the betting history data.

19. The non-transitory computer-readable storage media of claim 18, wherein the computer-executable instructions when executed, cause the one or more processors to:
update at least one of the one or more ML models to create an updated ML model using at least the selection of the promotion as a training input; and
deploy the updated ML model.

20. The non-transitory computer-readable storage media of claim 17, wherein the computer-executable instructions when executed, cause the one or more processors to authenticate the viewer of the gaming UI, wherein authenticating the viewer includes determining that the viewer is authorized to participate in the one or more promotions available from the one or more betting platforms.
